(19) United States
(12) Patent Application Publication
(10) Pub. No.: US 2005/0121827 A1
(43) Pub. Date: Jun. 9, 2005

(54) Method of heating in-mold coating composition

(75) Inventor: Glenn D. Williams, Holly, MI (US)

Correspondence Address: BROOKS KUSHMAN P.C. / LEAR CORPORATION, 1000 TOWN CENTER, TWENTY-SECOND FLOOR, SOUTHFIELD, MI, 48075-1238, US

(73) Assignee: Lear Corporation, Southfield, MI (US)

(21) Appl. No.: 10/731,794

(22) Filed: Dec. 9, 2003

(51) Int. Cl. B29C 41/08

(52) U.S. Cl. 264/255; 425/7

(57) ABSTRACT

A method of forming a polyurethane skin for an interior part of a vehicle having an in-mold coating. The in-mold coating composition is applied with an air assisted spray nozzle having an atomizing air stream that is heated to a temperature above ambient temperature. The heated air stream heats the in-mold coating composition as it is atomized and sprayed toward a forming surface by the spray nozzle. The layer of polyurethane is then applied over the in-mold coating layer to form a polyurethane skin. A heater heats compressed air before the compressed air is provided to the spray gun.

### BACKGROUND OF THE INVENTION

1. Field of the Invention

The present invention relates to an in-mold coating application process and system for making composite polyurethane skin products.

2. Background Art

Interior trim parts may be made with a vinyl or polyurethane skin that is subsequently filled with a foam material and secured to a structural member. Examples of interior trim components that are made according to this general process include instrument panel covers, arm rests, sun visors, center console covers, inner door panels, and the like. PVC or vinyl skins have long been used to make interior trim parts. Vinyl skins are generally rotocast from a liquid vinyl composition that is molded from a liquid vinyl composition having the desired color throughout the skin. In an effort to improve quality and durability, the use of polyurethane skins for interior trim components is being developed.

Polyurethane skins may be made of aliphatic polyurethane compositions that are molded in the desired color. However, difficulties may be encountered with aliphatic polyurethane compositions. Aliphatic polyurethane skins may suffer from color variation and poor surface finish caused by variations in the reaction of the polyurethane components.

In an effort to overcome problems with aliphatic polyurethane skins, applicants’ assignee has developed a method of making polyurethane skins in which a in-mold coating composition is applied to provide a consistent surface color and finish. An aromatic polyurethane composition that forms the body of the skin is applied over the in-mold coating. The in-mold coating is generally between 1 and 3 mils in thickness and is applied to a tool that is heated to approximately 160° F. The in-mold coating composition is preferably a water-based coating that has similarities to a water-based paint.

One problem associated with the use of an in-mold coating composition is that the coating is applied to surfaces in many different orientations ranging from vertical to horizontal and may be required to be applied in confined areas. To obtain a coating that completely covers the skin, it may be necessary to apply the in-mold coating composition in several passes to avoid sags or runs in the coating. The target thickness of 1 mil is sufficient to provide complete coverage but with many parts it is necessary to overlap the spray pattern that may result in in-mold coating thicknesses of between 3 and 4 mils. In areas where in-mold coating builds up, problems arise because the coating may run or sag. If the coating runs or sags, resultant defects in the surface finish of the finished skin may result in excessive scrap.

In addition, areas of increased thickness require additional flash time prior to application of the polyurethane body layer of the skin. If the in-mold coating composition is not completely flashed off, the in-mold coating composition may react with the isocyanate component of the aromatic polyurethane material. Interaction between the in-mold coating composition that is not completely flashed off and the isocyanate may result in surface imperfections and may render the skin unacceptable resulting in further scrap losses.

The flash time required for the in-mold coating composition may add to the cycle time for the skin manufacturing process. Generally, flash time should be less than 60 seconds. Any film build up in a range of 3 to 4 mils may require more than 60 seconds to completely flash off. Delays in the process increase cycle time and add cost to the manufacturing process.

The present invention is directed to solving the above problems and providing a reliable manufacturing process that results in polyurethane skins for interior components that have consistent color and surface finish while also minimizing cycle times.

### SUMMARY OF THE INVENTION

According to one aspect of the present invention, a method of forming a polyurethane skin for an interior part of a vehicle is provided. An air assisted spray nozzle having an atomizing air stream is provided. The in-mold coating composition is heated to a temperature above ambient temperature and is sprayed onto the mold release compound layer by the air assisted spray nozzle. A layer of polyurethane is then applied over the in-mold coating layer to form the polyurethane skin.

According to other aspects of the method of the present invention, the step of heating the in-mold coating composition may be performed by heating the atomizing air before the atomizing air is provided to the spray nozzle. In certain embodiments, the atomizing air stream may be heated to a temperature of between 100° F. and 200° F., while in other embodiments would be heated to a temperature of between 120° F. and 160° F. If the in-mold coating is heated in-line, the in-mold coating in some embodiments may be heated to a temperature of between 100° F. and 180° F., while in other embodiments would be heated to a temperature of between 140° F. and 180° F.

Other aspects of the invention relating to the application of the layer of aromatic polyurethane material further comprises applying a layer of polyurethane over the in-mold coating layer after a flash cycle. According to the method, the flash cycle may be 20% shorter than the flash cycle for application of an in-mold coating composition that is not heated above ambient temperature.

Another aspect of the present invention relates to a system for manufacturing a polyurethane skin for an interior part of a vehicle. The system includes a spray applicator for spraying a mold release compound layer onto a forming surface of an open die. An air compressor provides compressed air to an air assisted spray nozzle capable of producing an atomizing air stream. An air heater is used to heat the compressed air to a temperature above ambient temperature and to provide heated atomizing air. The air assisted spray nozzle uses the heated atomizing and fan spray air for spraying an in-mold coating composition layer over the mold release compound layer. A spray applicator is provided to apply a layer of polyurethane over the in-mold coating layer to form the polyurethane skin.

According to other aspects of the system of the present invention, the air heater may heat the atomizing air stream to a temperature of between 100° F. and 200° F., while according to other aspects between 120° F. and 160° F. The air heater heats the atomizing air to evaporate a solvent in the in-mold coating.

According to other aspects of the system of the present invention, the spray applicator is used to apply a layer of aromatic polyurethane over the in-mold coating layer after a flash cycle. The flash cycle may be 20% shorter than the flash cycle for an in-mold coating composition that is not heated by the atomization and fan spray air.

Another aspect of the invention relates to an in-mold coating composition spray system. The in-mold coating composition spray system comprises a drum containing a supply of in-mold coating composition that is connected to a fluid circuit. A pump is provided for pumping the in-mold coating composition from the drum and through the fluid circuit. A spray gun is connected to the fluid circuit that receives the in-mold coating composition from the pump. An air compressor provides compressed air through an air line to the spray gun to atomize the in-mold coating composition and direct the in-mold coating composition in a pattern. A heater is operative to heat the compressed air in the air line before the compressed air is provided to the spray gun.

According to other aspects of the invention as it relates to an in-mold coating composition spray system, the pattern in which the in-mold coating composition is directed is a fan shaped pattern. A color manifold station may also be provided wherein the in-mold coating composition is selected from a group of different colored in-mold coatings. The in-mold coating composition spray system may also include an air piloted pressure regulator in the fluid circuit immediately upstream from the spray gun.

These and other aspects of the present invention will be better understood in view of the attached drawings and following detailed description of a preferred embodiment of the invention.

### BRIEF DESCRIPTION OF THE DRAWINGS

FIG. 1 is a flow chart illustrating the method of forming a polyurethane skin for an interior part of a vehicle according to the present invention; and

FIG. 2 is a diagrammatic representation of an in-mold coating composition spray system made according to the present invention.

### DETAILED DESCRIPTION OF THE PREFERRED EMBODIMENT(S)

Reference will now be made in detail to presently preferred compositions, embodiments and methods of the present invention, which constitute the best modes of practicing the invention presently known to the inventors. However, it is to be understood that the disclosed embodiments are merely exemplary of the invention that may be embodied in various and alternative forms. Therefore, specific details disclosed herein are not to be interpreted as limiting, but merely as a representative bases for the claims and/or as a representative basis for teaching one skilled in the art to variously employ the present invention.

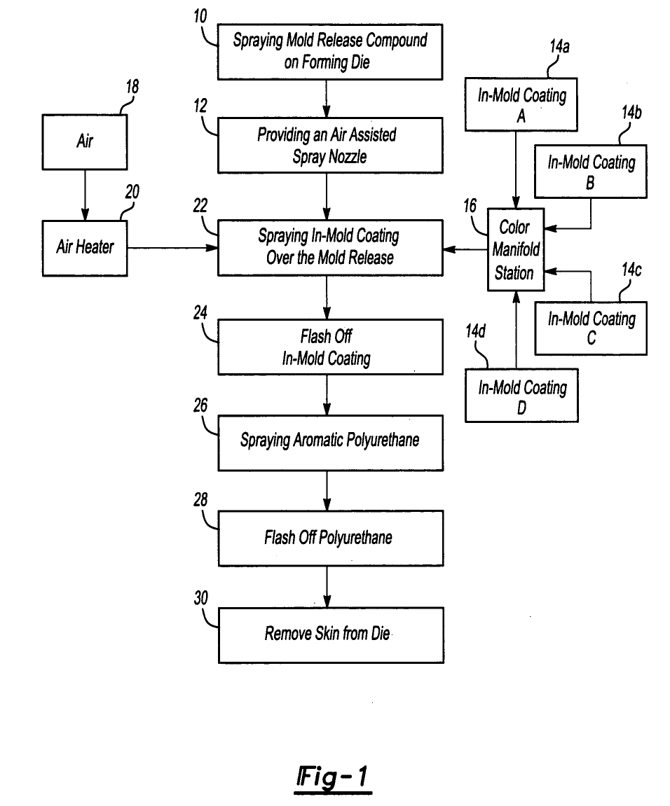

Referring to FIG. 1, a method of forming a polyurethane skin for an interior part of a vehicle is illustrated. In at least one embodiment, the first step of the process comprises spraying a mold release compound on a forming die or forming surface, at 10. At 12, an air assisted spray nozzle is provided for spraying an in-mold coating. At 14A-D, a plurality of in-mold coating compositions each having a different color are shown supplying in-mold coating compositions in different colors to a color manifold station, at 16. Air is obtained, at 18, that is provided to an air heater, at 20. Heated air is provided by the air heater, at 20, to the spray nozzle where it is combined, at 22, with the selected in-mold coating composition that is obtained from the color manifold station, at 16. The heated air is provided for atomizing and, if desired, may also be used for controlling the fan pattern spray air. As the in-mold coating composition is sprayed, at 22, the heated air heats the in-mold coating composition to a temperature above ambient temperature.

The heated air heats the in-mold coating composition as the in-mold coating composition is atomized by the spray nozzle prior to being applied over the mold release compound previously deposited on the forming die. In certain embodiments, the in-mold coating composition is heated by air that may be between 100° F. and 200° F. while in other embodiments the air may be between 120° F. and 160° F. The heated air heats the in-mold coating composition that in at least one embodiment is a water-based in-mold coating composition type of paint product. The heated air increases the evaporation of volatile material at the point of atomization to permit increased sag/run resistance and reduced flash times. The in-mold coating composition flashes off, at 24, to form an in-mold coating prior to application of a polyurethane composition, at 26.

In at least one embodiment, the polyurethane composition is an aromatic polyurethane composition including isocyanate and polyol components that combine to form a polyurethane skin that is bonded to the in-mold coating. The in-mold coating provides a uniform color layer over the polyurethane in the finished skin. The finished skin is subsequently processed to form an interior part of a vehicle. The polyurethane is permitted to flash off, at 28, to form a composition comprising a polyurethane layer bonded to the in-mold coating. The composite is removed from the die, at 30.

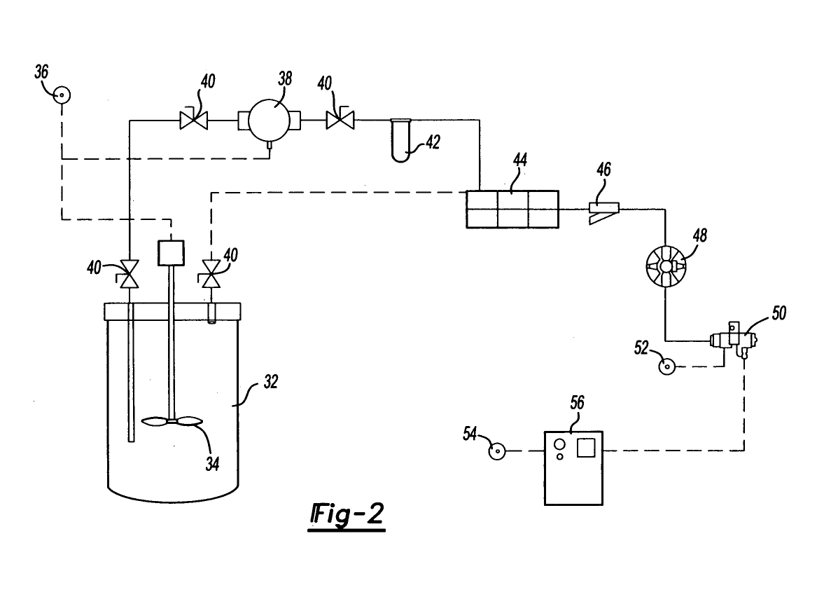

Referring to FIG. 2, the components of an in-mold coating composition spray system are illustrated. An in-mold coating composition is supplied in a drum 32 that is provided with an agitator 34 that is used to maintain the homogeneity of the in-mold coating. The agitator 34 may be pneumatically powered and, if so, receives compressed air from a main air supply 36. The main air supply 36 also provides power to a diaphragm pump 38 that is used to pump the in-mold coating composition from the drum 32. The fluid circuit illustrated in FIG. 2 includes several control valves 40 that may be used to control flow of in-mold coating composition through the fluid circuit, for example, when it is necessary to change a drum or clean the system. In at least one embodiment, the in-mold coating composition material is pumped by the diaphragm pump 38 through a mesh filter 42 that is used to filter impurities or large particles from the in-mold coating composition.

The in-mold coating composition is supplied to a color changer manifold 44 that may be mounted on a robot arm (not shown) to provide multiple colors for different color interior parts. Several in-mold coating composition supply fluid circuits such as that described above in connection with reference numerals 32-42 may be provided to the manifold 44. In at least one embodiment, a y-filter 46 receives the selected in-mold coating composition and provides it to an air piloted regulator 48 that regulates the pressure of the in-mold coating composition supplied to the air assisted spray gun 50. The air assisted spray gun 50 is controlled by an air solenoid trigger 52 that control application of the in-mold coating.

An air compressor 54 is a separate air compressor. Alternatively, compressed air could be provided by the main air supply 36. Air compressor 54 provides air to an air heater 56 that heats the air from the air compressor 54 to temperature above ambient. In at least one embodiment, the air heater 56 may provide air at a temperature between 100° F. and 200° F. but in other embodiments would provide air at a temperature between 120° F. and 160° F. The heated air is provided to the air assisted spray gun 50. As the heated air and in-mold coating composition pass through the air assisted spray gun 50 the heated air heats the in-mold coating composition as it is atomized. Heating the in-mold coating composition at the point of atomization causes the solvent material to evaporate at an increased rate. Increased evaporation of solvent materials increases resistance of the in-mold coating composition to sag or run and reduces the flash time for the in-mold coating.

While the above disclosed system and method use heated atomizing and fan spray air to heat the in-mold coating, it is also theorized that the in-mold coating material could be heated prior to being supplied to the spray gun. In one embodiment, the in-mold coating composition may be heated to about 160° F. In other embodiments the in-mold coating may be heated to a temperature of between 100° F. and 180° F., while in other embodiments it may be heated to a temperature of between 140° F. and 180° F.

Having generally described this invention, a further understanding can be obtained by reference to certain specific examples which are provided herein for purposes of illustration only and are not intended to be limiting unless otherwise specified.

The method and system were tested with a water-based paint similar to an in-mold coating composition to determine the effect of heating the atomizing air on the sag/run resistance and flash time.

The parameters of the test were as follows:
Turbo Spray Midwest HVLP gun;
gun distance from surface 6″;
9 psi fluid delivery;
3 psi airflow;
ambient paint temperature 78° F.;
humidity 52%;
United Paint AWHP—2146;
viscosity 27 secs Z3;
total volume solids 33%; and
ambient air temperature(84° F.), 160° F. and 275° F.
   The test was conducted using a sag panel comprising a commercially available sheet metal test panel having a plurality of holes that is used to test for dry film thickness (DFT) and sag resistance. The results of the test were based on single paint wedge application on steel sag panels were as follows:
Ambient: sag point 3.5 mils DFT and >5 mins flash @ 2.0 mils DFT
160° F.: sag point 6.0 mils DFT and <5 mins flash @ 2.0 mils DFT
275° F.: sag point 10.0 mils DFT and <4 mins flash @ 2.0 mils DFT
   At ambient temperature the sag point occurred at 3.5 mils DFT and more than five minutes was required to flash off the water base paint at a thickness of 2 mils. A marked improvement was observed at 160° F. wherein 6.0 mils DFT was obtained and the flash time was less than 5 minutes at 2 mils DFT. At 275° F. the sag point was 10.0 mils DFT and a flash of less than 4 minutes was obtained for 2.0 mils DFT. At 275° F. the water-based paint exhibited an distinct tendency to dry in the fluid tip. At 160°°F. and 275° F. there was no evidence of gas bubbles or pin holes in the coating.

Conclusions possible from the test are that heating the in-mold coating composition permits substantial increase in sag resistance and also noticeably reduces flash time. Extreme temperatures such as temperatures of 275° F. are not recommended due to problems relating to the tendency of the paint to dry in the fluid tip. The increase in sag resistance as measured by dry film thickness at 160° F. is expected to expand the application window for in-mold coating composition allowing for greater thicknesses without sags or runs in areas that are difficult to access.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

1. A method of forming a polyurethane skin for an interior part of a vehicle, comprising:
providing an air assisted spray nozzle capable of delivering an atomizing air stream;
heating an in-mold coating composition to a temperature above ambient temperature to create a heated in-mold coating composition;
spraying the heated in-mold coating composition towards a forming surface with the air assisted spray nozzle to create an in-mold coating layer; and
applying a layer of polyurethane over the in-mold coating layer to form the polyurethane skin.

2. The method of claim 1 wherein the step of heating the in-mold coating composition is performed by heating the atomizing air before the atomizing air is provided to the spray nozzle.

3. The method of claim 2 wherein the atomizing air stream is heated to a temperature of between 100° F. and 200° F.

4. The method of claim 2 wherein the atomizing air stream is heated to a temperature of between 120° F. and 160° F.

5. The method of claim 1 wherein the step of applying the layer of polyurethane is performed by spraying a layer of aromatic polyurethane over the in-mold coating layer after a flash cycle.

6. The method of claim 5 wherein the step of heating the in-mold coating composition is performed on the in-mold coating composition prior to entry of the in-mold coating composition into the spray nozzle, and wherein the in-mold coating is heated to a temperature of between 100° F. and 180° F.

7. A system for manufacturing a polyurethane skin for an interior part of a vehicle, comprising:
an air compressor for providing a compressed air to an air assisted spray nozzle having an atomizing air stream;
an air heater for heating the compressed air to a temperature above ambient temperature to provide heated atomizing air;
an air assisted spray nozzle using the heated atomizing air for spraying an in-mold coating composition layer toward a forming surface of a die; and
a spray applicator for applying a layer of polyurethane over the in-mold coating layer to form the polyurethane skin.

8. The system of claim 7 wherein the air heater heats the atomizing air stream to a temperature of between 100° F. and 200° F.

9. The system of claim 7 wherein the air heater heats the atomizing air stream to a temperature of between 120° F. and 160° F.

10. The system of claim 7 wherein the air heater heats the atomizing air to evaporate a solvent of the in-mold coating.

11. The system of claim 7 wherein the spray applicator for applying a layer of polyurethane over the in-mold coating layer applies an aromatic polyurethane after a flash cycle.

12. The system of claim 11 wherein the flash cycle is 20% shorter than a flash cycle for an in-mold coating composition applied without heating the atomization air.

13. An in-mold coating composition spray system, comprising:
a drum containing a supply of in-mold coating composition that is connected to a fluid circuit;
a pump for pumping the in-mold coating composition from the drum and through the fluid circuit;
a spray gun connected to the fluid circuit that receives the in-mold coating composition from the pump;
an air compressor for providing compressed air through an air line to the spray gun to atomize the in-mold coating composition and direct the in-mold coating composition in a pattern; and
a heater operative to heat the compressed air in the airline before the compressed air is provided to the spray gun.

14. The in-mold coating composition spray system of claim 13 wherein the compressed air is used to atomize the in-mold coating and also to direct the spray in a fan-shaped spray pattern.

15. The in-mold coating composition spray system of claim 13 further comprising a color manifold station connected to the fluid circuit wherein the in-mold coating composition is selected from a group of different color in-mold coatings.

16. The in-mold coating composition spray system of claim 13 further comprising an air piloted pressure regulator in the fluid circuit immediately up stream from the spray gun.
